(19) United States
(12) Patent Application Publication
(10) Pub. No.: US 2013/0284537 A1
(43) Pub. Date: Oct. 31, 2013

(54) Acoustic Assembly with Supporting Members

(71) Applicant: KNOWLES ELECTRONICS, LLC, Itasca, IL (US)

(72) Inventors: Janice LoPresti, Itasca, IL (US); Steven Roy Kearey, Carpentersville, IL (US); Felix Matthew Naylor, Chicago, IL (US); James Collins, Elk Grove Village, IL (US)

(73) Assignee: Knowles Electronics, LLC, Itasca, IL (US)

(21) Appl. No.: 13/870,362

(22) Filed: Apr. 25, 2013

Related U.S. Application Data
(60) Provisional application No. 61/638,836, filed on Apr. 26, 2012.

(51) Int. Cl. H04R 7/16

(52) U.S. Cl. CPC H04R 7/16
USPC 181/171

(57) ABSTRACT

An apparatus includes a top assembly, a bottom assembly, and a diaphragm assembly. The bottom assembly is coupled to the top assembly to form an overall assembly. The diaphragm assembly includes a ring and a diaphragm flexible member that is attached to the ring. The ring forms an opening and at least one strengthening member is disposed at least partially across the opening. The at least one strengthening member is configured to provide strength and maintain a predetermined compliance of the diaphragm flexible member.

### CROSS REFERENCE TO RELATED APPLICATION

This patent claims benefit under 35 U.S.C. §119 (e) to U.S. Provisional Application No. 61/638,836 entitled “Acoustic Assembly With Supporting Members” filed Apr. 26, 2012, the content of which is incorporated herein by reference in its entirety.

### TECHNICAL FIELD

This application relates to acoustic devices, and more specifically to the structural components of these devices.

### BACKGROUND OF THE INVENTION

The basic structure of a microphone is generally well known and includes a diaphragm which vibrates in response to changes in acoustic pressure. The diaphragm is a thin polymer film which needs to be held under a tension in order to provide a restoring force to move the diaphragm back towards the ring after it has been deflected. The diaphragm is typically attached to a ring within the microphone in order to provide the necessary tension. The deflection of the diaphragm in response to an acoustic pressure is inversely proportional to the tension. The output of the microphone is directly proportional to the deflection of the diaphragm. The tension on the film is also referred to as the compliance of the diaphragm and is precisely controlled.

The function of the support ring is to provide a means of indefinitely maintaining a constant tension in the diaphragm. The diaphragm film is fastened to the support ring at its perimeter, normally with adhesive. The support ring must provide adequate surface area for this bond such that the bond strength is sufficient to resist the tension in the diaphragm. The diaphragm has an area interior to the ring which is unsupported and free to move in response to acoustic pressure. In general, the microphone assembly is designed to maximize this area. The diaphragm film and support ring are referred to as the diaphragm assembly.

The diaphragm assembly may be supported by features in microphone housing such as bumps or semi perfs and is generally fastened to the microphone housing, thereby creating a sealed volume. The fastening is normally accomplished by adhesive, which forms a layer between the microphone housing and the diaphragm support ring. Therefore the diaphragm assembly is mechanically coupled to the microphone housing via support features and adhesive.

With respect to microphones, the sensitivity of the microphone will change if the compliance of the diaphragm changes, and changes in compliance can occur from environmental exposure and mechanical pressure, to mention two possible factors.

In addition, various factors can lead to deformation of the walls of the microphone housing. For instance, environmental changes and mechanical pressure can lead to the deformation of the walls. Since the diaphragm assembly is mechanically coupled to the housing, deformation of the wall can in turn exert pressure on the diaphragm assembly. Pressure can deform the support ring leading to changes in compliance and thus changes in sensitivity of the microphone and degrade performance of the acoustic device.

### BRIEF DESCRIPTION OF THE DRAWINGS

For a more complete understanding of the disclosure, reference should be made to the following detailed description and accompanying drawings wherein:

FIGS. 1A, 1B, and 1C comprise views of the bottom half of a acoustic device including the diaphragm assembly of the device without the flexible member shown according to various embodiments of the present invention;

FIGS. 1D and 1E comprise views of the bottom half of a acoustic device including the diaphragm assembly of the device according with a flexible member to various embodiments of the present invention;

FIGS. 2A, 2B, and 2C comprise views of a diaphragm assembly according to various embodiments of the present invention;

FIGS. 3A, 3B, and 3C comprise views of a diaphragm assembly according to various embodiments of the present invention;

FIGS. 4A, 4B, and 4C comprise views of the bottom half of an acoustic device or assembly including a reinforcing plate according to various embodiments of the present invention;

FIGS. 5A, 5B, and 5C comprise views of the complete acoustic device or assembly of FIGS. 4A, 4B, and 4C including a reinforcing plate according to various embodiments of the present invention;

FIGS. 6A, 6B, and 6C comprise views of the bottom half of an acoustic device or assembly including a reinforcing plate according to various embodiments of the present invention;

FIGS. 7A, 7B, and 7C comprise views of the complete acoustic device or assembly of FIGS. 6A, 6B, and 6C including a reinforcing plate according to various embodiments of the present invention;

FIG. 8 comprises a cross sectional view of an acoustic device or assembly according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein. It will be understood that support members can be implemented in other devices with diaphragm assemblies such as a receiver that typically includes a diaphragm, coil, magnets, a reed, among other components and these components are housed within the receiver housing.

### DETAILED DESCRIPTION

Approaches are provided that offer structural supports for diaphragm assemblies (and other elements) in acoustic devices or assemblies (such as microphone or receiver modules). The approaches described herein are easy and cost effective to implement, are effective to minimize changes of compliance of the diaphragm and thereby improve the performance of the device, and, in some cases, are effective to support other elements of the acoustic device or assembly.

An apparatus includes a top assembly, a bottom assembly, and a diaphragm assembly. The bottom assembly is coupled to the top assembly to form an overall assembly. The diaphragm assembly includes a ring and a diaphragm flexible member that is attached to the ring. The ring forms an opening and at least one strengthening member is disposed at least partially across the opening. The at least one strengthening member is configured to provide strength and maintain a predetermined compliance of the diaphragm flexible member. In some aspects, the top assembly or the bottom assembly may include at least one additional component such as a back plate, or a microelectromechanicalsystem (MEMS) component. Other examples are possible.

In others of these embodiments, an apparatus includes a top assembly, a bottom assembly, and a reinforcing plate. The bottom assembly is coupled to the top assembly to form an overall assembly. The reinforcing plate is attached to one of the top assembly or bottom assembly and extends at least partially across the length of the overall assembly, providing strength to the apparatus. The top assembly or the bottom assembly are configured to include at least one additional component. In some aspects, the component is one or more of a diaphragm, a back plate, or a microelectromechanicalsystem (MEMS) component. Other examples are possible.

In some aspects, the reinforcing plate includes one or more openings extending therethrough. In other aspects, the reinforcing plate is constructed of metal. In still other aspects, the acoustic apparatus includes a diaphragm assembly, and the diaphragm assembly includes a ring and a diaphragm flexible member. The diaphragm ring provides strength to maintain a predetermined compliance of the diaphragm flexible member.

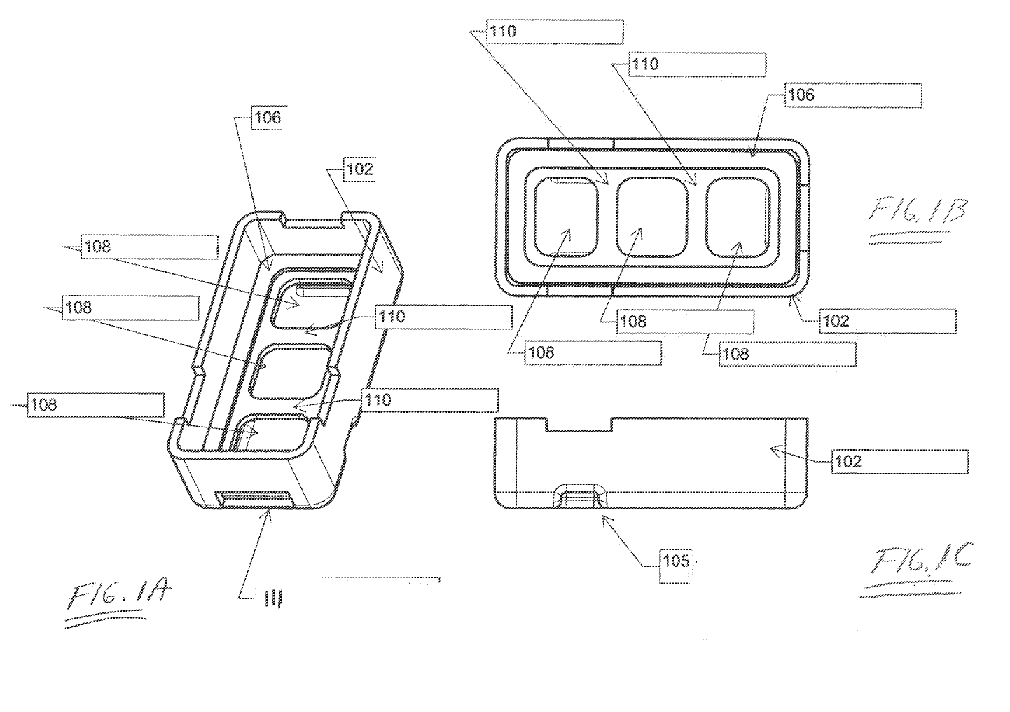

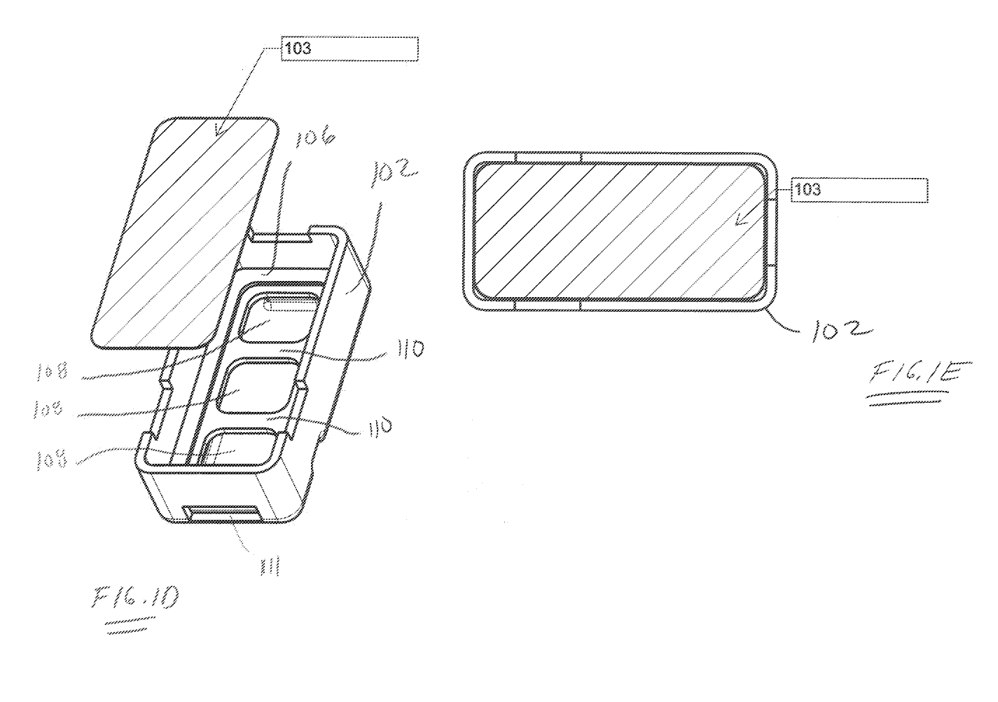

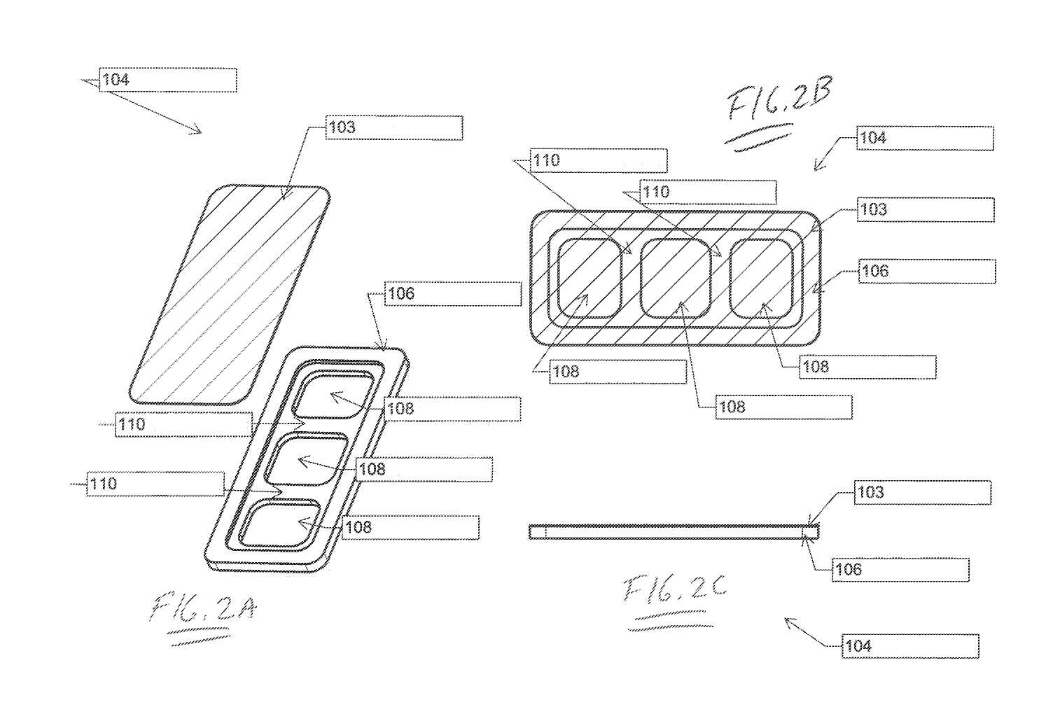

Referring now to FIGS. 1A, 1B, 1C, 1D, 1E, 2A, 2B, and 2C, an acoustic device 100 (including a diaphragm assembly) is described. In this example, the device 100 is a microphone. However, it will be appreciated that the principles described herein can also be applied to other types of device such as receivers. The portion of the acoustic device shown in these figures includes a bottom cup (housing portion) 102 and a diaphragm assembly 104. A bump 105 is formed in the housing 102 and supports diaphragm assembly 104. The diaphragm assembly 104 includes a ring 106 and a diaphragm flexible member 103. The diaphragm flexible member 103 is a film or membrane and is attached to the ring 106. The member 103 vibrates upon application of sound pressure creating a change in voltage between the diaphragm assembly 103 and back plate (not shown in these figures) in proportion to change in sound pressure as known to those skilled in the art. An opening or inlet such as a slot 111 in the housing 102 allows sound to enter the device.

In one aspect, the ring 106 is formed of a single piece of metal and has two bars 110 across central span that form three openings 108 extending therethrough. Other construction materials and configurations are possible. For instance, if the overall shape of the ring can vary to match dimensions of the bottom cup 102. It will be appreciated that the strength provided by the assembly 104 (i.e., using the crossbars 110) maintains a diaphragm flexible member 103 in position thereby maintaining the compliance (tension) of the diaphragm flexible member 103. Bars must be formed such that surface of bar does not contact diaphragm membrane during operation of device. If part is fabricated with a stamping process then this may be achieved by coining the area of ring which includes bar(s) but not area in which membrane or film is attached. The supporting structure may include one or more bars spanning the width or length of ring (totally or partially). It may have a sufficient number of bars and sufficient size to mechanically reinforce ring and be small enough width as to keep openings 108 sufficiently large as to not impede flow of air from sound inlet 111 to diaphragm flexible member 103.

In one example, the compliance of the member 103 is maintained within a range of 0.5 E−14 m³/Pa (acoustic Farad SI). Consequently, microphone performance is maintained within acceptable operating thresholds even under environmental changes (e.g., changes in temperature or humidity) or mechanical forces (e.g., exerted pressure or force on the device 100).

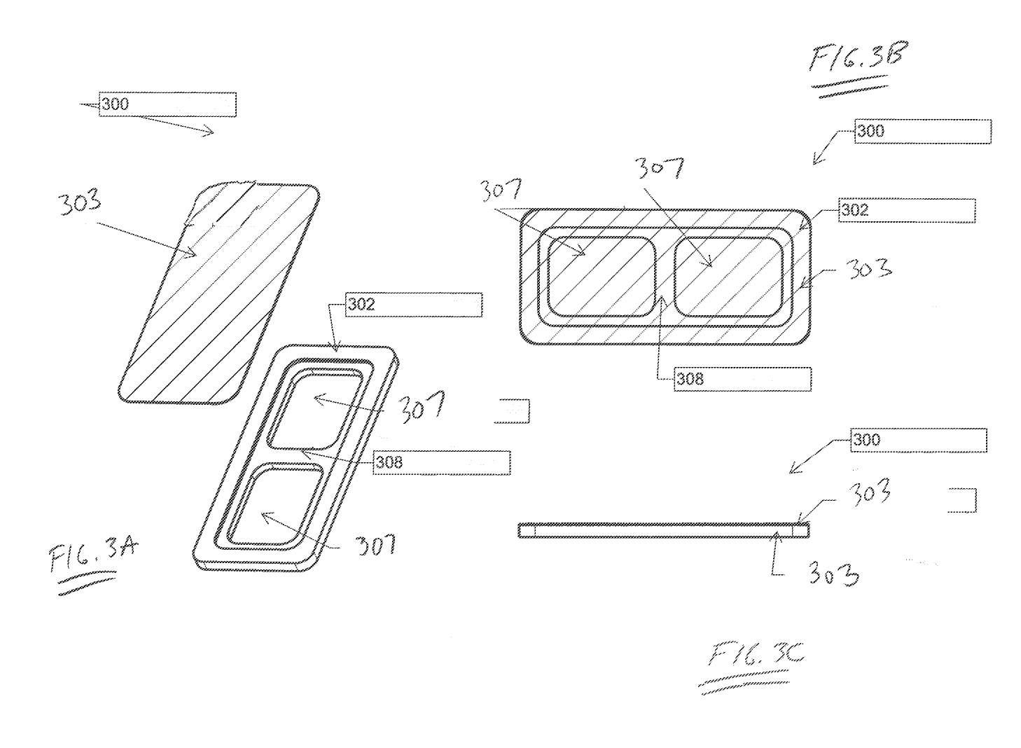

Referring now to FIGS. 3A, 3B, and 3C, an alternative diaphragm assembly 300 is described. The diaphragm assembly 300 includes a ring 302 and a diaphragm flexible member 303. The ring 302 is formed of a single piece of metal and has one bar 308 across central span that forms two openings 307 extending there through. Other examples of construction materials and configurations can also be used. A bar 308 extends between the openings 307. It will be appreciated that the strength provided by the assembly 300 (i.e., using the crossbar 308) maintains the diaphragm flexible member in position thereby maintaining the compliance tension of the diaphragm flexible member. Bars must be formed such that surface of bar does not contact diaphragm membrane during operation of device. If part is fabricated with a stamping process then this may be achieved by coining the area of ring which includes bar(s) but not area in which membrane or film is attached. Consequently, microphone performance is maintained within acceptable operating thresholds even under environmental changes or mechanical pressure.

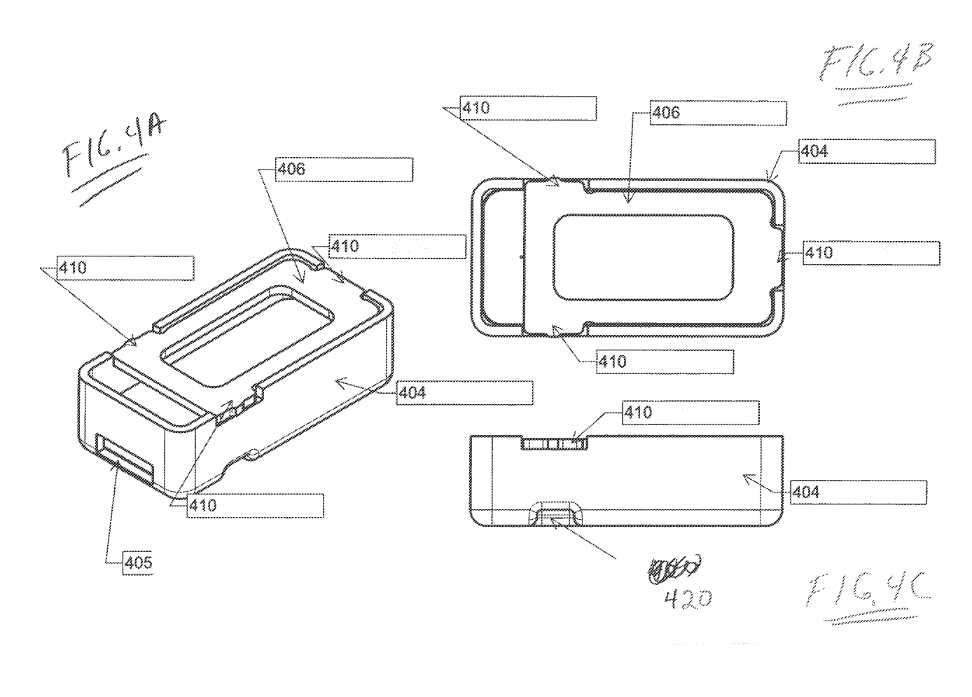

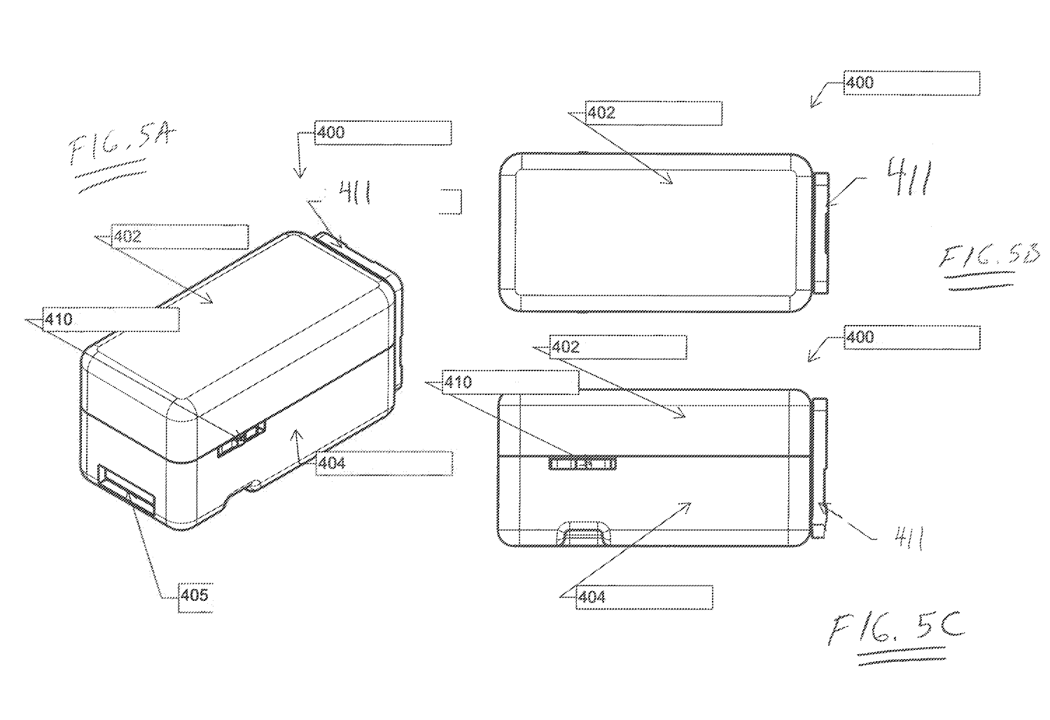

Referring now to FIGS. 4A, 4B, 4C, 5A, 5B, and 5C, an acoustic assembly (microphone) 400 that includes a reinforcing plate is described. The assembly 400 includes a top cup (housing) 402 and a bottom cup (housing) 404. A reinforcing plate 406 has an opening 408 and includes tabs 410. Notches 412 are formed in the bottom cup 404 and the tabs 410 of the plate 406 are received in these notches. Together, the tabs 410 are supported in the notches 412 of the bottom cup 404 and this arrangement supports the plate 406. The tabs 410 extend through and are exposed at the exterior of the assembly 400. The two cups 402 and 404 are placed together to form the assembly 400. A bump 420 provides support for the diaphragm assembly.

The reinforcing plate 406 supports components of the assembly 400 and may be constructed of some metal or some other suitable strong material. For example, a circuit (e.g., application specific integrated circuit (ASIC)) may be disposed at the top of the reinforcing plate 406. The plate 406 also provides a structural reinforcement to the bottom cup 404 so that mechanical stress and forces that impact the device are not passed on to a diaphragm assembly that is disposed in the interior of the assembly 400 (in a manner, for example, as shown in FIGS. 1-3). A port 405 is formed in the bottom cup 404. The port allows sound to enter the assembly and move the diaphragm. Terminals 411 provide electrical contacts for connections external to the device.

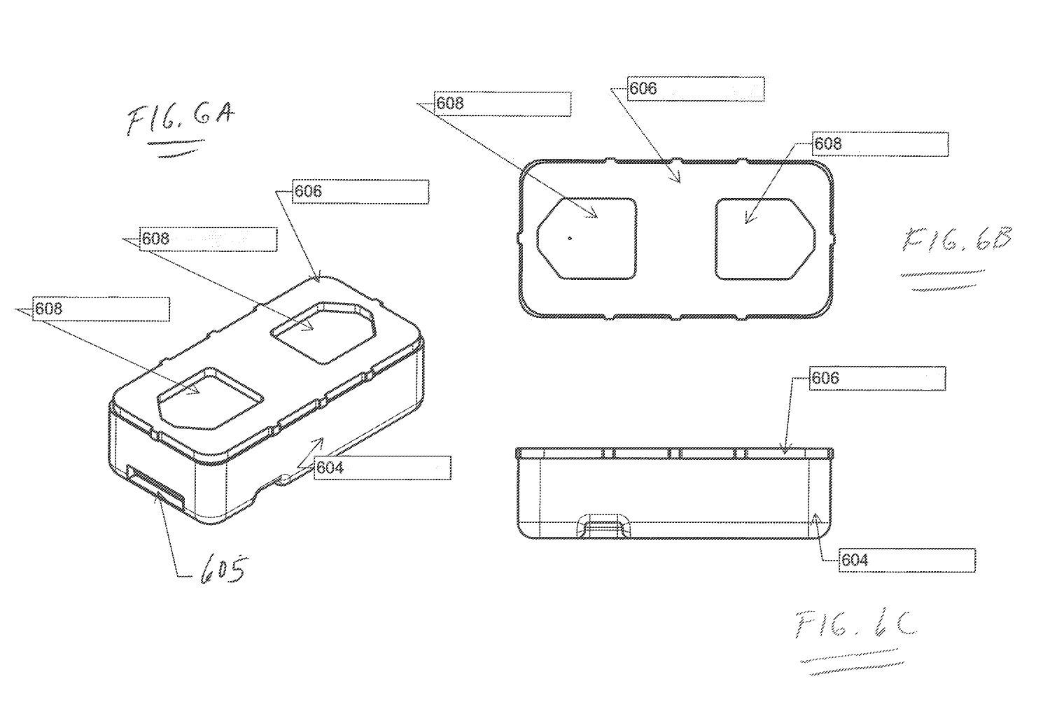

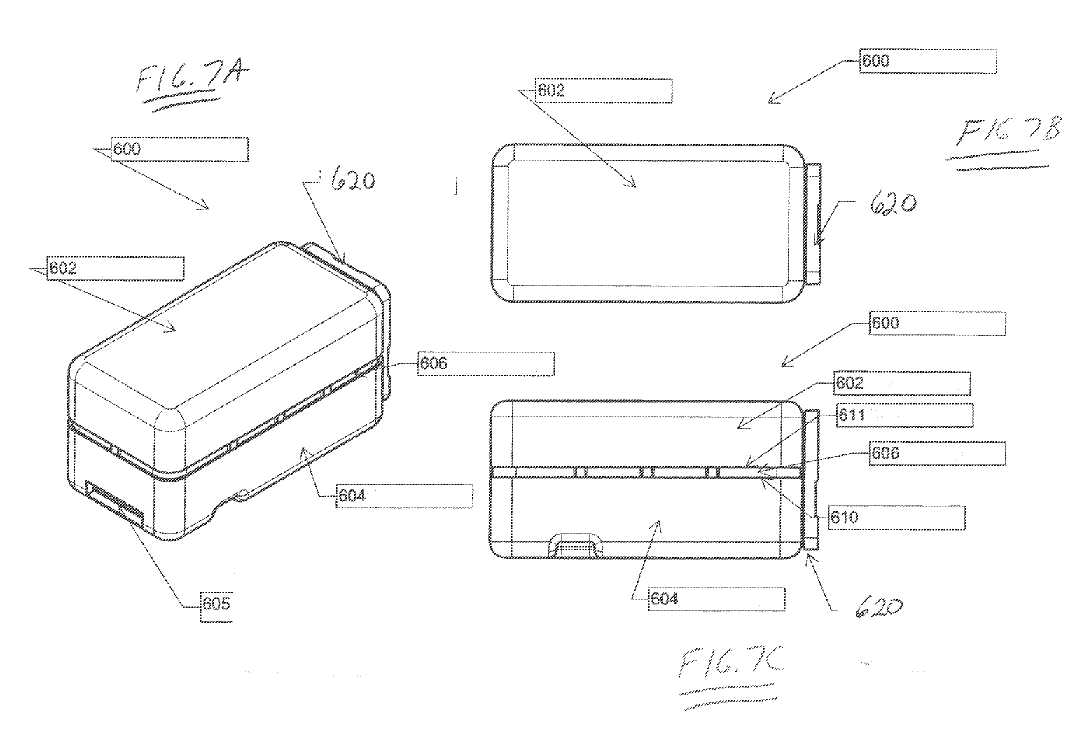

Referring now to FIGS. 6A, 6B, 6C, 7A, 7B, and 7C, another acoustic assembly (a microphone) 600 including a reinforcing plate 606 is described. The assembly 600 includes a top cup (housing) 602 and a bottom cup (housing) 604. A reinforcing plate 606 has openings 608 formed there through. The plate 608 is disposed to rest upon a lip 610 of the bottom cup 604 and rests and/or is otherwise attached thereon. Consequently, the plate 606 is sandwiched between a lip 611 of the cup 602 and the lip 610 of the cup 604. In one aspect, the plate 606 is exposed at the exterior of the assembly 600. The two cups 602 and 604 (with the plate 606 disposed there between) are placed together to form the assembly 600. Terminals 620 provide electrical contacts for connections external to the device. An inlet 605 is formed in the bottom cup 604 and allows sound to enter the device 600.

The reinforcing plate 606 supports components of the assembly 600. The reinforcing plate 606 may be constructed of some metal or some other suitable strong material. For example, a circuit (e.g., an ASIC) may be disposed at the top of the reinforcing plate 606. The plate 606 also provides a structural reinforcement so that mechanical stress and forces that impact the device 600 are not passed on to a diaphragm assembly that is disposed in the interior of the assembly in a manner, for example, as shown in FIGS. 1-3.

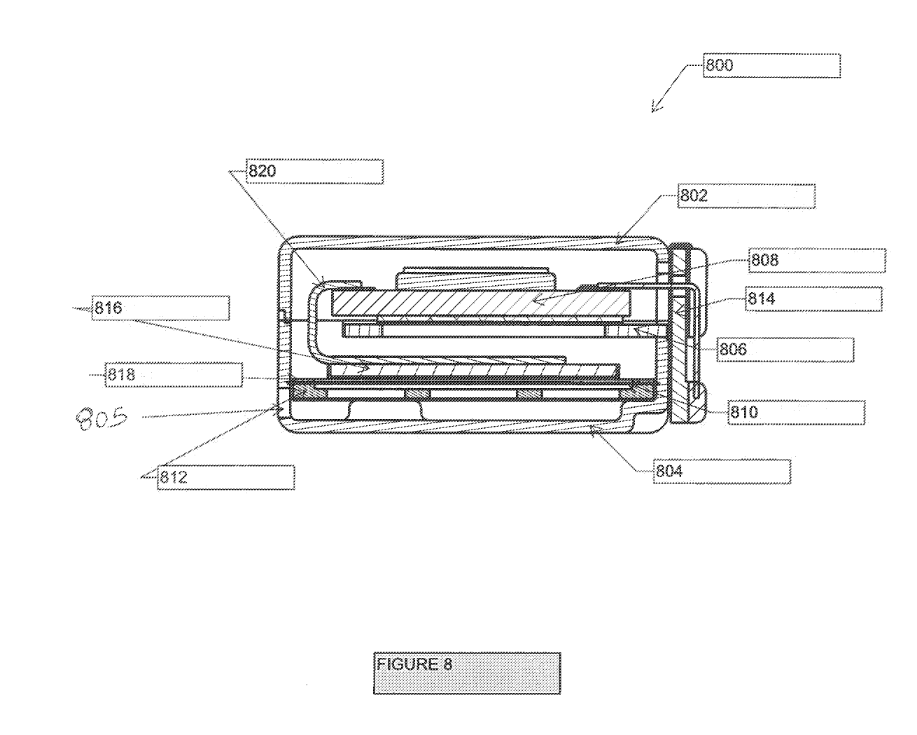

Referring now to FIG. 8, an acoustic assembly 800 with plate and ring is described. The assembly 800 (in the case of a microphone) includes a top cup (housing) 802, a bottom cup (housing) 804, a plate 806, a circuit or hybrid 808 that is disposed on the plate 806, a film or membrane 810, a diaphragm ring 812, a tab or terminal 814, a back plate 816, a spacer 818, and a wire 820.

The top cup 802 and the bottom cup 804 are housing elements that are secured together to form the assembly 800. The reinforcing plate 806 is constructed of metal or some other suitable construction material to support the circuit 808 and provide structural strength against forces impacting the assembly 800.

An inlet 805 allows sound to enter the device. The flexible film or membrane 810 moves in response to change in acoustic pressure. The film or membrane 810 is attached to the diaphragm ring 812. The ring 812 may be formed according to any of the structures described elsewhere herein and maintains the stiffness of the diaphragm membrane 810 during the application of mechanical or environmental forces to the assembly 800. The spacer 818 controls the separation between the diaphragm assembly and the back plate 816. The back plate 816 consists of a conductive plate and electrically-charged film. An electrical signal is created as the film or membrane 810 is moved by varying sound pressure through inlet. The wire 820 provides an electrical connection between the back plate 816 and the circuit 808. The circuit or hybrid 808 that is disposed on the plate 806 is any suitable processing circuit. In this regard, it may be an ASIC. Other examples of circuits are possible. The tab or terminal 814 provides an electrical connection to the exterior.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An apparatus, comprising:
a top assembly;
a bottom assembly, the bottom assembly coupled to the top assembly to form an overall assembly; and
a diaphragm assembly, the diaphragm assembly including a ring and a diaphragm flexible member attached to the ring, wherein the ring forms an opening, wherein at least one strengthening member is disposed at least partially across the opening, and wherein the at least one strengthening member is configured to provide strength and maintain a predetermined compliance of the diaphragm flexible member.

2. The apparatus of claim 1 wherein the top assembly or the bottom assembly additionally comprises a back plate or a microelectromechanicalsystem (MEMS) die.

3. An apparatus, comprising:
a top assembly;
a bottom assembly, the bottom assembly coupled to the top assembly to form an overall assembly;
a reinforcing plate attached to one of the top assembly or bottom assembly, the reinforcing plate extending at least partially across the length of the overall assembly and providing strength to the apparatus;
wherein the top assembly or the bottom assembly are configured to include at least one additional component.

4. The apparatus of claim 3 wherein the at least one additional component is one or more of a diaphragm, a back plate, or a microelectromechanicalsystem (MEMS) die.

5. The apparatus of claim 3 wherein the reinforcing plate includes one or more openings extending therethrough.

6. The apparatus of claim 3 wherein the reinforcing plate is constructed of metal.

7. The apparatus of claim 3 wherein the acoustic apparatus includes a diaphragm assembly, and the diaphragm assembly includes a ring and a diaphragm flexible member, wherein the diaphragm ring provides strength to maintain a predetermined compliance of the diaphragm flexible member.
